(19) United States
(12) Patent Application Publication
(10) Pub. No.: US 2025/0124335 A1
(43) Pub. Date: Apr. 17, 2025

(54) Network Information Scanning System

(71) Applicant: MICRO FOCUS LLC, SANTA CLARA, CA (US)

(72) Inventors: DOUGLAS MAX GROVER, RIGBY, ID (US); MICHAEL F. ANGELO, HOUSTON, TX (US)

(73) Assignee: MICRO FOCUS LLC, SANTA CLARA, CA (US)

(21) Appl. No.: 18/379,492

(22) Filed: Oct. 12, 2023

(51) Int. Cl. G06N 20/00

(52) U.S. Cl. CPC G06N 20/00

(57) ABSTRACT

A training corpus for training a similarity algorithm is retrieved. For example, the training corpus may be source code of a software application. The similarity algorithm is trained using the training corpus. A network is crawled to identify data. For example, the Internet may be randomly crawled to identify source code. The data is run through the similarity algorithm to determine a likely match between the training corpus and the identified data on the network. In response to determining the likely match between the training corpus and the identified data on the network, an action is taken. For example, the action may be to identify a particular website as containing illegally copied source code of the software application.

### FIELD

The disclosure relates generally to identifying specific types of information on a network and in particular to mitigating issues related to the different types of information that is identified on the network.

### BACKGROUND

Currently the ability to discover illegal copying of information is often difficult to detect. Copying software, literary works, music, publications, images etc. can be easily accomplished with limited detection. For example, the illegal copying of software can be difficult to detect and can lead to misuse, such as lost software sales, generation of malicious web sites, and/or the like.

Likewise, identifying patent infringement is also difficult to detect. Oftentimes, patent infringement may go undetected because of the difficulty in identifying if the software is actually infringing.

Moreover, discovery of malware on websites is also difficult to detect because the malware is constantly changing or new variants of the malware are being created.

### SUMMARY

These and other needs are addressed by the various embodiments and configurations of the present disclosure. The present disclosure can provide a number of advantages depending on the particular configuration. These and other advantages will be apparent from the disclosure contained herein.

A training corpus for training a similarity algorithm is retrieved. For example, the training corpus may be source code of a software application. The similarity algorithm is trained using the training corpus. A network is crawled to identify data. For example, the Internet may be randomly crawled to identify source code. The data is run through the similarity algorithm to determine a likely match between the training corpus and the identified data on the network. In response to determining the likely match between the training corpus and the identified data on the network, an action is taken. For example, the action may be to identify a particular website as containing illegally copied source code of the software application.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

As defined herein and in the claims, the term “source code” may include any type of source code, such as, firmware, software, binaries, interpreted source code (e.g., Java code), and/or the like.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for crawling a network to identify data usage.

FIG. 2 is a block diagram of a second illustrative system for crawling a network to identify data usage.

FIG. 3 is a flow diagram of a process for using a training corpus to train a similarity algorithm.

FIG. 4 is a flow diagram of a process for crawling a network to identify data usage.

FIG. 5 is a flow diagram of a process for mutating a training corpus to identify data usage.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

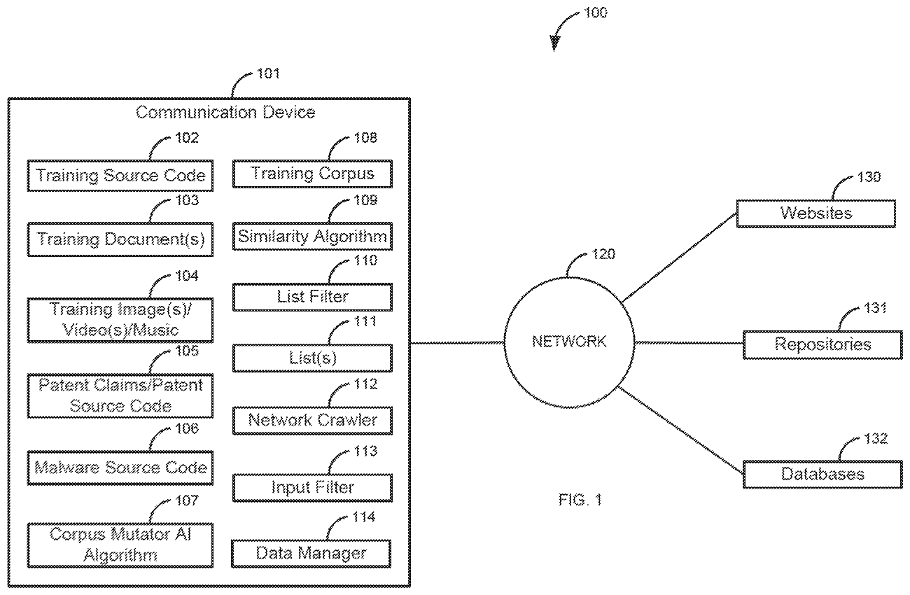

FIG. 1 is a block diagram of a first illustrative system 100 for crawling a network 120 to identify data usage. The first illustrative system 100 comprises a communication device 101, a network 120, websites 130, repositories 131, and databases 132.

The communication device 101 can be or may include any user communication device that can communicate on the network 120, such as a Personal Computer (PC), a Personal Digital Assistant (PDA), a tablet device, a notebook device, a smartphone, a laptop computer, and/or the like. While only a single communication device 101 is shown, there may be any number of communication devices 101 connected to the network 120.

The communication device 101 comprises training source code 102, training documents 103, training image(s)/video(s)/music 104, patent claims/patent source code 105, malware source code 106, a corpus mutator AI algorithm 107, a training corpus 108, a similarity algorithm 109, a list filter 110, list(s) 111, a network crawler 112, an input filter 113, and a data manager 114.

The training source code 102 is any software/firmware that is used to train the similarity algorithm 109. The training source code 102 may be components software/firmware used to build a software/firmware application. The source code software 102 may be libraries, open-source software, proprietary software, third-party software, website software, binaries, and/or the like. The training source code 102 may be in various programming languages, such as Java, JavaScript, Hyper-Text Markup Language (HTML), C, C++, Pearl, shell script, and/or the like.

The training documents 103 may comprise any types of documents in various types of formats. For example, the training documents 103 may be documents owned by a company, documents authored by a specific user/group of users, literary works of an author or group of authors, music sheets, spreadsheets, employee lists, and/or the like.

The training image(s)/video(s)/music 104 can be or may include any type of images, videos, and/or music. For example, the images 104 may be pictures, digital artwork, photos, and/or the like. The videos 104 may comprise personal videos, movies, video podcasts, television broadcasts, video recordings, audio/video streams and/or the like. The music 104 can comprise musical soundtracks, music in a video, albums by a group, audio recordings, and/or the like.

The patent claims/patent source code 105 can be or may include one or more claims of a patent/patent application. The patent source code 105 can include source code/binaries that infringes one or more patent claims. For example, the patent source code 105 may be source code from a library that infringes a patent claim. The patent claims/patent source code 105 may include documentation about the patent, such as, a patent document, a patent application publication, and/or the like.

The malware source code 106 can be source code/binaries of various types of malware, such as, viruses, trojan horses, key stroke logging malware, denial of service malware, access breaching malware, spyware, adware, a computer worm, an internet bot, a logic bomb, and/or the like. The malware source code 106 may be in various programming languages.

The corpus mutator AI algorithm 107 can be any AI algorithm that can mutate data. For example, the AI algorithm 107 may mute different types of source code/binaries, such as the training source code 102, the patent source code 105, and the malware source code 106. In other words, the corpus mutator AI algorithm 107 can mutate any kind of software/firmware/binaries. The corpus mutator AI algorithm 107 can mutate the software based on input from a user.

In addition, the corpus mutator AI algorithm 107 may mutate other types of data, such as the training documents 103, the training image(s)/video(s)/music 104 and/or the like. For example, the corpus mutator AI algorithm 107 may be trained using the training documents 103 to produce different mutations (e.g., derivative works) of the training documents 103. Likewise, the corpus mutator AI algorithm 107 may be trained using the training image(s)/video(s)/music 104 to produce mutated (changed) derivative works of the images/videos/music. The mutations can then be used to train the similarity algorithm 109.

The training corpus 108 is the data that is used to train the similarity algorithm 109. The training corpus 108 may be filtered data. For example, the input filter 113 may filter the training source code 102 to produce the training corpus 108. The training corpus 108 may comprise mutated data and/or non-mutated data.

The similarity algorithm 109 can be any algorithm that can identify similarities in data, such as, a vector Artificial Intelligence (AI)/machine learning algorithm, a snippet comparison algorithm, a hash snippet comparison algorithm, and/or the like. For example, the similarity algorithm 109 may use vectors that create numbers where the vectors/numbers that are close to each other have similar data. The similarity algorithm 109 may identify similarities in source code, binaries, documents, images, videos, music, patent claims, patent documentation, malware source code 106, trademarks, and/or the like.

The list filter 110 is used to filter identified addresses (e.g., addresses of the websites 130, repositories 131, and/or databases 132) based on the list(s) 111. For example, the list 111 may be a list of websites 130 of customers who have legitimate copies of a software application that was used to train the similarly algorithm 109.

The network crawler 112 can any hardware/software that can be used to crawl the network 120 (e.g., the websites 130, the repositories 131, the databases 132, and/or the like) to capture data that is run through the similarity algorithm 109. The network crawler 112 may randomly crawl the network 120, may crawl the network 120 based on a list of addresses, based on user input, and/or the like.

The input filter 113 can be used to filter data (e.g., software, documents, images, music, videos, music, patent claims, malware, and/or the like) to produce the training corpus 108 that is used to train the similarly algorithm 109. The input filter 113 may be displayed to a user where the user can select specific files/documents to filter out to produce the training corpus 108.

The data manager 114 can be or may include any hardware coupled with software that manages the training, filtering, network crawling processes described herein. The data manager 114 can manage what data is used to create the training corpus 108 to train the similarity algorithm 109. The data manager 114 may manage the corpus mutator AI algorithm 107 with input to define how the corpus mutator AI algorithm 107 mutates the different types of data in the training corpus 108.

The network 120 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 120 can use a variety of electronic protocols, such as Ethernet, Internet Protocol (IP), Hyper Text Transfer Protocol (HTTP), Web Real-Time Protocol (Web RTC), and/or the like. Thus, the network 120 is an electronic communication network 120 configured to carry messages via packets and/or circuit switched communications.

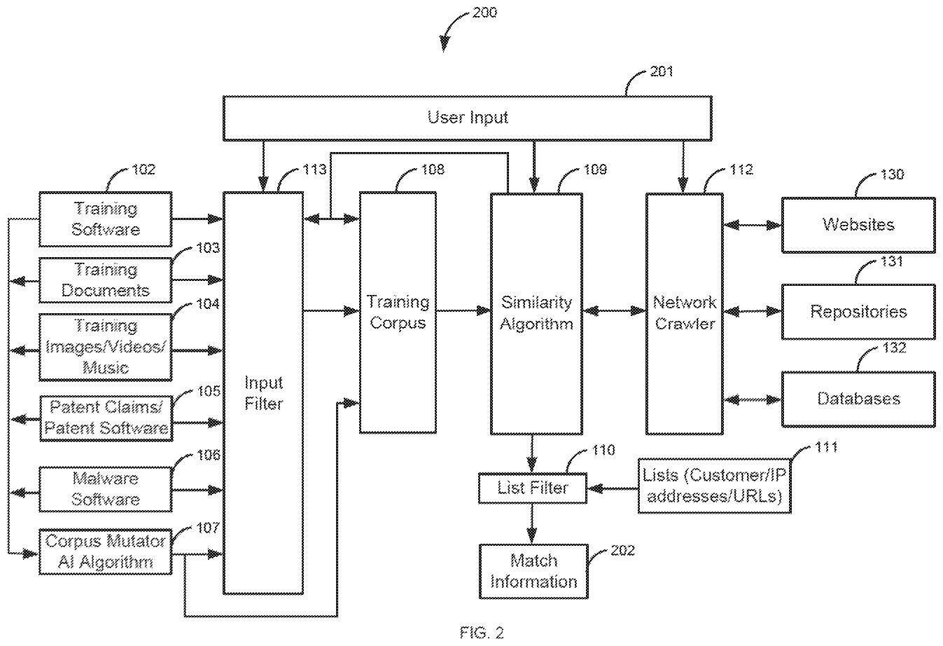

FIG. 2 is a block diagram of a second illustrative system 200 for crawling a network. 120 to identify data usage. The second illustrative system 200 comprises the training source code 102, the training documents 103, the training image(s)/video(s)/music 104, the patent claims/patent source code 105, the malware source code 106, the corpus mutator AI algorithm 107, the training corpus 108, the similarity algorithm 109, the list filter 110, the list(s) 111 (customer/Internet Protocol (IP) addresses/Universal Resource Locators (URLs), the network crawler 112, the input filter 113, the websites 130, the repositories 131, the databases 132, user input 201, and matching information 202.

Depending on what data (the training source code 102, the training documents 103, the training images/videos/music 104, the patent claims/patent source code 105, the malware source code 106, and/or mutated data) the user wants to select (the user input 201), the user filters out any unwanted data, using the input filter 113, to produce the training corpus 108. In FIG. 2, the mutated data may be fed directly into the training corpus 108 (e.g., bypassing the input filter 113). The training corpus 108 may be tied to a specific person/group/company/entity. For example, source code/documents/music of a specific person, specific to a company, specific to a group etc. may be used in the training corpus 108 to train the similarity algorithm 109.

Based on the user input 201, the similarity algorithm 109 is then trained using the training corpus 108. Once the similarity algorithm 109 is trained, the user (user input 201) then has the network crawler 112 crawl the network 120. The network crawler 112 may crawl the websites 130, the repositories 131, the databases 132 and/or other sources on the network 120. The network crawler 112 may crawl the network 120 randomly, based on rules, based on the user input 201, and/or the like. Any number of the websites 130, the repositories 131, and/or the databases 132 may be crawled by the network crawler 112. For example, if the training corpus 108 is source code for a software application, the network crawler 112 can get source code from the websites 130 (e.g., source code for the web pages), source code from the repositories 131, source code from the database 132, and/or the like to determine if the websites 130, the repositories 131 and/or the databases 132 have matching source code.

The data from the network crawler 112 is then run through the similarity algorithm 109 to determine a likely match between the training corpus 108 and the data from the network 120. For example, the similarity algorithm 109 may identify personal patterns in the training documents 103 associated with the user and then look for similar documents that use similar drafting patterns. If the similarity algorithm 109 uses a vector AI algorithm, the distances in the vectors are used to determine the similarities. If snippets are used, the similarity algorithm 109 matches snippets from the training corpus 108 to snippets of the crawled software. If hashes of snippets are used, the similarity algorithm 109 matches hashes of snippets from the training corpus 108 to hashes of snippets of the crawled software. While these are some of the possibilities for matching source code/data, one of skill in the art would recognize that other matching algorithms may be used.

In response to a likely match (e.g., based on a threshold) between the training corpus 108 and the identified data on the network 120, and action is taken. For example, the action may be to flag that an address of a website 130 is compromised or is likely compromised. The match information may include location information about where the matching information came from (e.g., a URL, an IP address, a database identifier, a country, a city, etc.), details of the match (e.g., showing input source code verses matching source code, trained images versus crawled images, etc.), and/or the like.

In one embodiment, the matched information 202 and/or the output of the similarity algorithm 108 may be fed back and included in the training corpus 108. In addition, the matched information 202 and/or the output of the similarity algorithm 109 may be feedback as an input to the input filter 113.

The matching information may be filtered using the list filter 110. For example, if the training corpus 108 is software for an application, the list filter 110 may be used to websites 130 of customers who have legitimate copies of the software application. Thus, only illegitimate copies of the software application may be identified by the matching information 202. If the data is music, the trained music may be shown where the user can then play music from the training corpus 108 and then play the crawled music. If the music is composed music (e.g., sheet music), the trained sheet music can be shown in relation to the crawled sheet music. The matching information 202 may identify the likelihood of a match (e.g., a percentage).

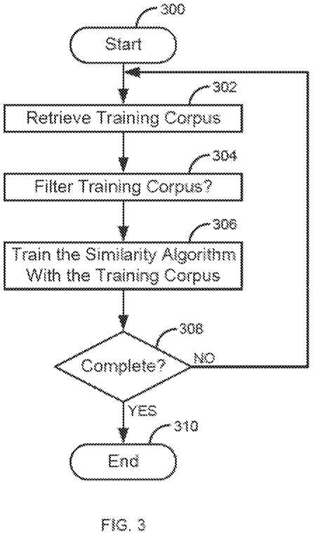

FIG. 3 is a flow diagram of a process for using a training corpus 108 to train the similarity algorithm 109. Illustratively, the communication device 101, the training source code 102, the training documents 103, the training image(s)/video(s)/music 104, patent claims/patent source code 105, the malware source code 106, the corpus mutator AI algorithm 107, the training corpus 108, the similarity algorithm 109, the list filter 110, the lists 111, the network crawler 112, the input filter 113, the data manager 114, the websites 130, the repositories 131, and the databases 132 are stored-program-controlled entities, such as a computer or microprocessor, which performs the method of FIGS. 3-5 and the processes described herein by executing program instructions stored in a computer readable storage medium, such as a memory (i.e., a computer memory, a hard disk, and/or the like). Although the methods described in FIGS. 3-5 are shown in a specific order, one of skill in the art would recognize that the steps in FIGS. 3-5 may be implemented in different orders and/or be implemented in a multi-threaded environment. Moreover, various steps may be omitted or added based on implementation.

The process starts in step 300. The data manager 114 retrieves the training corpus 108 in step 302. The retrieving of step 302 may be based on the user input 201, may be based on defined rules, and/or the like. The input filter 113 filters the training corpus 108 in step 304. The input filter 113 may filter the training corpus 108 in various ways, such as based on the user input 201, based on defined rules (e.g., filtering out specific open-source licenses), and/or the like. The similarity algorithm 109 is trained, in step 306, by running the training corpus 108 through the similarity algorithm 109.

The data manager 114 determines, in step 308, if the process is complete. If the process is not complete in step 308, the process goes back to step 302. Otherwise, if the process is complete in step 308, the process ends in step 310.

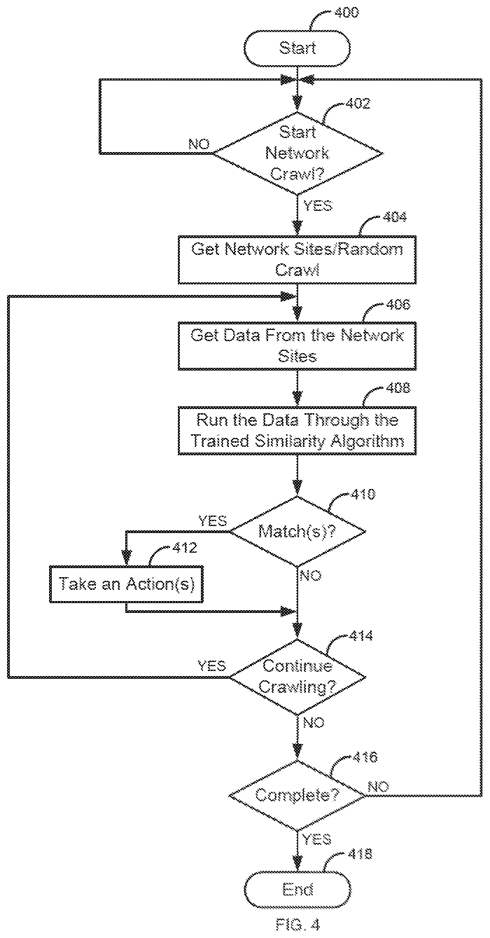

FIG. 4 is a flow diagram of a process for crawling a network 120 to identify data usage. The process starts in step 400. The network crawler 112 determines, in step 402, whether to start crawling the network 120. The network crawler 112 may start crawling the network 120 based on user input, based on defined rules, based on an event, and/or the like. If the network crawler 112 has not received a request to start crawling the network 120, in step 402, the process of step 402 repeats.

Otherwise, if a request to start crawling the network 120 is received in step 402, the network crawler 112 gets the addresses of the network sites (e.g., the websites 130, the repositories 131, and/or the databases 132, if it is not a random crawl) in step 404. The network crawler 112 gets data from the network sites in step 406. The data taken from the network sites may be specific types of information, such as, source code, documentation, images, videos, music, malware source code, and/or the like. For example, a filter may be defined on what data to capture on a specific network site. The amount of data that is processed over time may comprise exceptionally large amounts of information. For example, there are currently over 1.13 billion websites 130 on the Internet as of 2023. If the crawl is a random crawl of the Internet, the amount of captured data may be incredibly large.

The data is run through the trained AI algorithm 109, in step 408, to identify any matches. If there are one or more match(s) in step 410, one or more actions may be taken in step 412 and the process goes to step 414. Otherwise, if there is not a match in step 410, the crawler determines, in step 414, if crawling the network 120 should continue. If the network 120 is still to be crawled in step 414, the process goes back to step 406. For example, to start crawling a new website 130. Otherwise, if the network crawling is complete in step 414, the network crawler 112 determines, in step 416, if the process is complete. If the process is not complete in step 416, the process goes to step 402. Otherwise, if the process is complete in step 416, the process ends in step 418.

To illustrate the process of FIG. 4, consider the following examples. In one embodiment, the training corpus 108 may comprise source code of a software application. If there is a match in step 410, the action taken in step 412 may be to flag an address on the network 120 (e.g., an IP address or URL) has having source code of the software application or likely having source code of the software application (e.g., there is an illegal copy of the software application). The addresses may be filtered based on a list of legitimate copies of the software application. For example, the list may be a list of URLs of companies/individuals who have purchased legitimate copies of the software application.

In one embodiment, the training corpus 108 may comprise other information than source code, such as, documents, images, videos, and/or music. If there is a match in step 410, the action taken in step 412 may be to flag an address on the network 120 (e.g., an IP address or URL) as having illegal copyrighted material or likely having illegal copyrighted material.

In one embodiment, the training corpus 108 may comprise source code that infringes a patent (the patent source code 105). If there is a match in step 410, the action taken in step 412 may be to indicate that the crawled source code infringes the patent, likely infringes the patent, infringes a portion of the patent, and/or a likely infringes portion of the patent.

In one embodiment, the training corpus 108 may comprise one or more documents that describe claims of a patent. If there is a match in step 410, the action of step 412 may be to flag an address on the network 120 (e.g., an IP address or URL) for having one or more documents that indicates potential infringement of the patent.

In another embodiment, the training corpus 108 may comprise both source code and other types of data. For example, the training corpus 108 may comprise patent claims and source code that infringes a patent (the patent source code 105). In this embodiment, the patent claims may also be used to train the similarity algorithm 109 where each step in the claim is tied to specific lines of patent source code 105. If there are matches, the matched sourced code may be displayed along with the corresponding patent claims and/or patent source code 105. If only a portion of the patent claims are implemented, a list showing which elements are potentially infringed may be displayed to a user.

The patent search process could be extended further to search documents that have similar descriptions to patent claims. In this embodiment, the training corpus 108 may be patent claims (the text of the patent claims) and then infringing documents that describe the patent claims. The document searching may be combined with the source code search process to not only identify source code, but also to show related documents.

The process could be trained using logos trademarks, images, watermarks, stenographic information, and/or the like. This could be used to identify websites 131 that are illegally using the logos/trademarks and/or fake websites 131 that are similar to a legitimate website 130.

In one embodiment, when a match occurs in step 410, the action taken in step 412 may be to provide the identified data back to the training corpus 108. For example, if there is source code that matches step 410, the identified source code may become part of the training corpus 108. In other words, the identified data may be used to retrain the similarity algorithm 109.

In one embodiment, the training corpus 108 may comprise source code for malware. If there is a match of the malware (e.g., on a website 130), the action taken in step 412 may be to flag an address on the network 120 (e.g., an IP address or URL) as being compromised or likely being compromised. This information can also be used to block the web site via a firewall. Alternatively, the website owner may be notified that the website 130 has malware. If the owner wants to know about the malware, the owner can pay a fee.

This process can be used to identify AI generated code that was trained using proprietary source code. The comparison would show the original source code and the similarities in the derivative work. It could also show the likelihood that it came from the source corpus.

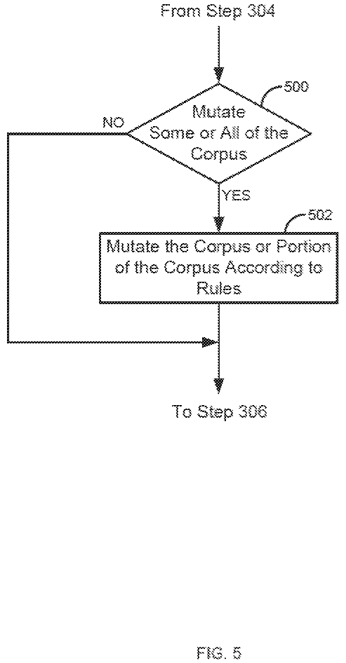

FIG. 5 is a flow diagram of a process for mutating a training corpus 108 to identify the data usage. The process of FIG. 5 goes between step 304 and 306 of FIG. 3.

After filtering the training corpus 108 in step 304, the data manager 114 determines, in step 500, if some or all of the training corpus 108 is to be mutated. If none of the training corpus 108 is to be mutated in step 500, the process then goes to step 306.

Otherwise, if some or all of the training corpus 108 is to be mutated in step 500, the corpus mutator AI algorithm 107 mutates the training corpus 108 according to the rules in step 502 and/or user input. For example, if the training corpus 108 comprises both patent claim source code and patent claims, the rules may only specify to mutate the patent claim source code. The corpus mutator AI algorithm 107 can mutate some or all of the training corpus 108 to create diverse types of source code/data such as, source code that infringes patent claims, source code that may be derived from an application, data that may derived from malware, images, music, documents, and/or the like. The process then goes to step 306.

In one embodiment, the training source code 102 may be input into the AI source code mutator algorithm 107 (e.g., source code of a software application) to produce AI generated source code that performs the same function (a new derivative work). This can then be used as part of the training corpus 108 used to train the similarity algorithm 109.

In one embodiment, the training corpus 108 may comprise malware code that has been mutated by the corpus mutator AI algorithm 107. If there is a match, the action taken in step 412 may be to flag an address on the network 120 (e.g., an IP address or URL) as being compromised or likely being compromised.

In one embodiment, the training corpus 108 may comprise source code of a software application where at least a portion of the source code has been mutated by the corpus mutator AI algorithm 107 and wherein the action of step 412 may be to flag an address on the network 120 (e.g., an IP address or URL) has having source code derived from the software application or likely having source code derived from the software application.

In one embodiment, the training corpus 108 may not include any source code (e.g., the training corpus 108 may comprise music). In this example, all or at least a portion of the training corpus 108 may have been mutated by the corpus mutator AI algorithm 107.

This systems/process described herein could be provided as a Software as a Service (SaaS) product. For example, a tenant can pay to train using their specific training corpus 108 of data/source code and the receive results of a search on the network 120.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® is-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
retrieve a training corpus for training a similarity algorithm;
train the similarity algorithm using the training corpus;
crawl a network to identify data;
run the data through the similarity algorithm to determine a likely match between the training corpus and the identified data on the network; and
in response to determining the likely match between the training corpus and the identified data on the network, take an action.

2. The system of claim 1, wherein the training corpus comprises malware source code and wherein the action is to flag an address on the network as being compromised or likely being compromised.

3. The system of claim 1, wherein the training corpus comprises malware source code that is mutated by an artificial intelligence algorithm and wherein the action is to flag an address on the network as being compromised or likely being compromised.

4. The system of claim 1, wherein the training corpus comprises source code that infringes a patent and wherein action is to flag an address on the network as having source code that infringes the patent, likely infringes the patent, infringes a portion of the patent, and/or a likely infringes portion of the patent.

5. The system of claim 1, wherein the training corpus comprises source code of a software application and wherein the action is to flag an address on the network as having the source code of the software application or likely having the source code of the software application.

6. The system of claim 5, wherein flagging the address on the network as having the source code of the software application or likely having the source code of the software application is completed in response to the address on the network not being in a list of legitimate copies of the software application.

7. The system of claim 1, wherein training corpus comprises at least one of: documents, images, videos, and music and wherein the action is to flag an address on the network as having illegal copyrighted material and/or likely having illegal copyrighted material.

8. The system of claim 1, wherein the training corpus comprises one or more documents that describes claims of a patent and wherein the action is to flag an address on the network as having one or more documents that indicates potential infringement of the patent.

9. The system of claim 1, wherein the training corpus comprises source code of a software application where at least a portion of the source code has been mutated by an artificial intelligence algorithm and wherein the action is to flag an address on the network has having source code derived from the software application and/or likely having source code derived from the software application.

10. The system of claim 1, wherein the training corpus is not source code and wherein at least a portion of the training corpus has been mutated by an artificial intelligence algorithm.

11. The system of claim 1, wherein the training corpus comprises patent claims and source code that infringes a patent.

12. The system of claim 1, wherein the data that is a likely match between the training corpus and the identified data on the network is used to retrain the similarity algorithm.

13. A method comprising:
retrieving, by a microprocessor, a training corpus for training a similarity algorithm;
training, by the microprocessor, the similarity algorithm using the training corpus;
crawling, by the microprocessor, a network to identify data;
running, by the microprocessor, the data through the similarity algorithm to determine a likely match between the training corpus and the identified data on the network; and
in response to determining the likely match between the training corpus and the identified data on the network, taking, by the microprocessor, an action.

14. The method of claim 13, wherein the training corpus comprises malware source code and wherein the action is to flag an address on the network as being compromised or likely being compromised.

15. The method of claim 13, wherein the training corpus comprises malware source code that is mutated by an artificial intelligence algorithm and wherein the action is to flag an address on the network as being compromised or likely being compromised.

16. The method of claim 13, wherein the training corpus comprises source code that infringes a patent and wherein action is to flag an address on the network as having source code that infringes the patent, likely infringes the patent, infringes a portion of the patent and/or a likely infringes portion of the patent.

17. The method of claim 13, wherein the training corpus comprises source code of a software application and wherein the action is to flag an address on the network as having the source code of the software application or likely having the source code of the software application.

18. The method of claim 13, wherein training corpus comprises at least one of: documents, images, videos, and music and wherein the action is to flag an address on the network as having illegal copyrighted material and/or likely having illegal copyrighted material.

19. The method of claim 13, wherein the training corpus comprises source code of a software application where at least a portion of the source code has been mutated by an artificial intelligence algorithm and wherein the action is to flag an address on the network has having source code derived from the software application or likely having source code derived from the software application.

20. A non-transient computer readable medium having stored thereon instructions that cause a processor to execute a method, the method comprising instructions to:
retrieve a training corpus for training a similarity algorithm;
train the similarity algorithm using the training corpus;
crawl a network to identify data;
run the data through the similarity algorithm to determine a likely match between the training corpus and the identified data on the network; and
in response to determining the likely match between the training corpus and the identified data on the network, take an action.
